(19) United States
(12) Patent Application Publication
(10) Pub. No.: US 2024/0425037 A1
(43) Pub. Date: Dec. 26, 2024

(54) VEHICLE CONTROL DEVICE AND METHOD

(71) Applicant: Honda Motor Co., Ltd., Tokyo (JP)

(72) Inventors: Kentaro KASUYA, Tokyo (JP); Tomohiro HOSONO, Tokyo (JP)

(73) Assignee: Honda Motor Co., Ltd., Tokyo (JP)

(21) Appl. No.: 18/608,964

(22) Filed: Mar. 19, 2024

(30) Foreign Application Priority Data
Jun. 20, 2023 (CN) 202310734472.9

(51) Int. Cl. B60W 30/06; B60W 10/04; B60W 10/184; B60W 10/20

(52) U.S. Cl. CPC B60W 30/06; B60W 10/04; B60W 10/184; B60W 10/20; B60W 2510/18; B60W 2520/14; B60W 2710/18

(57) ABSTRACT

Disclosed are a vehicle control device and method. The vehicle control device includes: a turning state detection part for detecting whether the vehicle is in a turning state based on the driving state of the vehicle; a vehicle speed detection part for detecting whether the vehicle speed of the vehicle is equal to or less than a predetermined threshold; a braking force distribution control part for distributing and controlling the braking force of each wheel of the vehicle based on the driving state and the vehicle speed; and a brake noise detection part for detecting the brake noise of each of the wheels. When the braking force distribution control part controls the braking force and the brake noise occurs for multiple times within a predetermined time, the braking force distribution control of the braking force distribution control part is suppressed.

### CROSS-REFERENCE TO RELATED APPLICATION

This application claims the priority benefit of Chinese application serial no. 202310734472.9, filed on Jun. 20, 2023. The entirety of the above-mentioned patent application is hereby incorporated by reference herein and made a part of this specification.

### BACKGROUND

### Technical Field

The disclosure relates to a vehicle control device and method.

### Description of Related Art

In recent years, proactive efforts have been made to provide access to sustainable transportation systems that also take into account the disadvantaged people, such as the elderly, handicapped people, or children, in transportation. In order to achieve the above purpose, research and development have been carried out to further improve the safety and convenience of transportation through the developments related to vehicle habitability.

In the case where a vehicle is turning at low speeds, when the distribution of braking force to the left and right wheels of the vehicle is controlled, stick-slip phenomenon occurs to the friction material of the brakes, which causes brake noise. Stick-slip means that two objects contacting each other in the manner of sliding and fixing in intermittent motion rather than continuous smooth sliding during sliding contact. To address this problem, related art Patent Document 1 (JP Laid-Open No. 2008-105589) prevents brake noise by reducing the additional braking force applied to inner wheels while the vehicle is traveling.

In related art Patent Document 1 (JP Laid-Open No. 2008-105589), even if the control is performed during low-speed cornering, the brake noise might not be fully prevented in some cases. Brake noise might change due to various factors such as deterioration of friction materials, temperature, humidity, and the bite of foreign objects. In particular, when brake noise continues to occur, it is desirable that the brake noise can be inhibited.

However, in terms of vehicle habitability, how to eliminate the brake noise when the vehicle turns at low speeds is a problem to be solved.

### SUMMARY

In order to solve the above-mentioned problem, the disclosure aims to suppress the brake noise when the vehicle turns at low speeds, and in turn contribute to the development of sustainable transportation systems.

According to an embodiment of the present disclosure, a vehicle control device is provided. The vehicle control device includes: a turning state detection part for detecting whether the vehicle is in a turning state based on the driving state of the vehicle; a vehicle speed detection part for detecting whether the vehicle speed of the vehicle is equal to or less than a predetermined threshold; a braking force distribution control part for distributing and controlling the braking force of each wheel of the vehicle based on the driving state and the vehicle speed; and a brake noise detection part for detecting the brake noise of each of the wheels. In the case where the braking force distribution control part controls the braking force and the vehicle is in the turning state when the vehicle speed is equal to or less than the predetermined threshold, as the brake noise occurs for multiple times within a predetermined time, the braking force distribution control executed by the braking force distribution control part is suppressed.

According to another embodiment of the present disclosure, a vehicle control method is provided. The vehicle control method includes: detecting whether the vehicle is in a turning state based on the driving state of the vehicle; detecting whether the vehicle speed of the vehicle is equal to or less than a predetermined threshold; distributing and controlling the braking force of each wheel of the vehicle based on the driving state and the vehicle speed to perform braking force distribution control; detecting the brake noise of each wheel; and in controlling the braking force, when the vehicle is in the turning state and the vehicle speed is equal to or less than the predetermined threshold, as the brake noise occurs for multiple times within a predetermined time, suppressing the braking force distribution control.

According to the above embodiment, when the vehicle speed is equal to or less than the predetermined threshold and the vehicle is in a low-speed state, as the brake noise continues to occur, the braking force distribution control may be prohibited from operating, thereby inhibiting the occurrence of brake noise.

### BRIEF DESCRIPTION OF THE DRAWINGS

FIG. 1 is a block diagram of a vehicle control device according to an embodiment of the present disclosure.

FIG. 2 is a block diagram of a brake noise detection part according to an embodiment of the present disclosure.

FIG. 3A and FIG. 3B are schematic diagrams of continuous detection of brake noise according to embodiments of the present disclosure.

FIG. 4 is a block diagram of a brake noise detection part according to another embodiment of the present disclosure.

### DESCRIPTION OF THE EMBODIMENTS

Reference will now be made in detail to the exemplary embodiments of the present disclosure, examples of which are illustrated in the accompanying drawings. Whenever possible, the same reference numbers are used in the drawings and descriptions to refer to the same or similar parts.

According to an embodiment of the present disclosure, the vehicle control device may further include a braking device that applies a braking force to the vehicle based on the driver's operation on the brake operating part. When the vehicle speed is equal to or less than the predetermined threshold and the braking force distribution control is terminated, the braking device generates the braking force corresponding to the operation of the brake operating part.

According to an embodiment of the present disclosure, the vehicle control device may further include: a power switch configured to cause the driving source of the vehicle to operate according to the driver's operation. When the vehicle speed is equal to or less than the predetermined threshold and the braking force distribution control is suppressed, the braking force distribution control part maintains a state in which the braking force distribution control executed by the braking force distribution control part is suppressed until the power switch is turned off.

According to an embodiment of the present disclosure, the vehicle control device may further include: an automatic parking control part configured to at least control the steering device of the vehicle according to the driving state of the vehicle to move the vehicle to a parking position. When the braking force distribution control is suppressed and the automatic parking control part is performing the automatic parking control, the steering device is controlled so that the turning radius of the vehicle is smaller than the current turning radius.

According to an embodiment of the present disclosure, in the vehicle control device, the brake noise detection part includes: a sound pressure sensor that detects the brake noise, and an unsprung acceleration sensor that detects unsprung acceleration of the vehicle. The vehicle control device may further include a determining part that determines the brake noise based on detection results of the sound pressure sensor and the unsprung acceleration sensor. When the vehicle speed is equal to or less than the predetermined threshold, and the determining part determines that the brake noise occurs for multiple times, the braking force distribution control part suppresses the braking force distribution control.

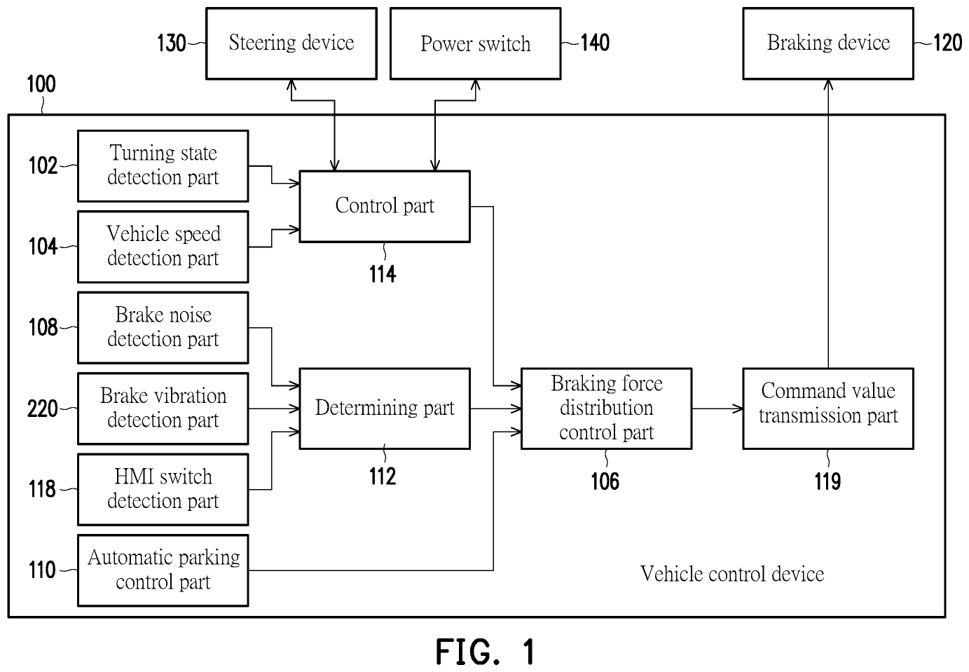

FIG. 1 is a block diagram of a vehicle control device according to an embodiment of the present disclosure. As shown in FIG. 1, the vehicle control device 100 at least includes but is not limited to: a turning state detection part 102, a vehicle speed detection part 104, a braking force distribution control part 106, a brake noise detection part 108, an automatic parking control part 110, a determining part 112, a control part 114, a brake vibration detection part 220, an HMI switch detection part 118 and a command value transmission part 119. In addition, the vehicle control device 100 may also at least include but not limited to: a braking device 120, a steering device 130 and a power switch (start switch) 140.

Each part or each device illustrated in FIG. 1 may be controlled by the control part 114. The control part 114 controls the vehicle. The control part 114 may control various operation modes of the vehicle, such as acceleration and deceleration, parking, avoidance, etc. For those skilled in the art, various control methods of the control part 114 may be designed according to actual needs. The control part 114 may be implemented by a processor, such as an ECU

(Electronic Control Unit) of the vehicle. The ECU may be used to control various sensors and detectors of the vehicle. As a result, the control part 114 may receive data, perform various processing and judgments on the data, and then control various actuating components of the vehicle. Various system controls in a car are executed by the ECU, for example, including the start of the vehicle (such as the power switch (start switch) 140), inspection of various parts after the start, control of the vehicle display, etc. The turning state detection part 102 detects whether the vehicle is in a turning state based on the driving state of the vehicle. The turning state may be determined, for example, based on the steering angle (or operation angle) of the steering wheel (steering device 130) mounted in the vehicle. In an example, the turning state detection part 102 may be implemented by a steering angle sensor and the control part 114 mounted on the steering device 130. The sensor is disposed to detect the rotation angle of the steering device 130 relative to a reference position to determine whether the vehicle is in a turning state. The reference position may generally be a position where the steering device 130 is in a position where the steering wheels of the vehicle (for example, the left and right wheels in front) keep the vehicle going straight. The rotation angle of the steering device 130 detected by the sensor may be processed and analyzed by the control part 114 on the signal to obtain whether the vehicle is in a turning state.

The vehicle speed detection part 104 is disposed to detect whether the vehicle speed is equal to or less than a predetermined threshold. The vehicle speed detection part 104 may be implemented by a vehicle speed sensor and the control part 114, for example. The vehicle speed sensor is, for example, a sensor mounted near the wheel to detect the rotational speed to obtain the vehicle speed. The vehicle speed may also be detected using various available sensors, such as image analysis and processing after capturing by a camera, radar, LiDAR and other available technical means, which are not particularly limited by the present disclosure. When the vehicle speed sensor detects the vehicle speed of the vehicle, the control part 114 may compare the detected vehicle speed with a predetermined threshold and determine whether the vehicle speed is equal to or less than the predetermined threshold.

The braking force distribution control part 106 distributes and controls the braking force of each wheel of the vehicle based on the driving state and vehicle speed of the vehicle. The braking force distribution control performed by the braking force distribution control part 106 is a vectoring control. In particular, when the vehicle makes a turn, the braking force and turning radius of each wheel of the left and right front wheels and the left and right rear wheels may be controlled. The braking force distribution control part 106 may receive the vehicle speed detected by the vehicle speed detection part 104 and the operating angle (steering angle) of the steering device (steering wheel) 130 detected by the turning state detection part 102, thereby confirming the driving state of the vehicle.

In this embodiment, the control part 114 receives the detection results from the turning state detection part 102 and the vehicle speed detection part 104, and controls the braking force distribution control part 106. Furthermore, the determining part 112 receives the detection results from the brake noise detection device 108 and the brake vibration detection part 220, and transmits the judgment results to the braking force distribution control part 106. The braking force distribution control part 106 performs distribution of braking force based on the outputs from the control part 114 and the determining part 112 (or further includes the automatic parking control part 110), and transmits the results to the command value transmission part 119 to transmit the command values distributed by the braking force of each wheel to each wheel braking device to generate corresponding braking force.

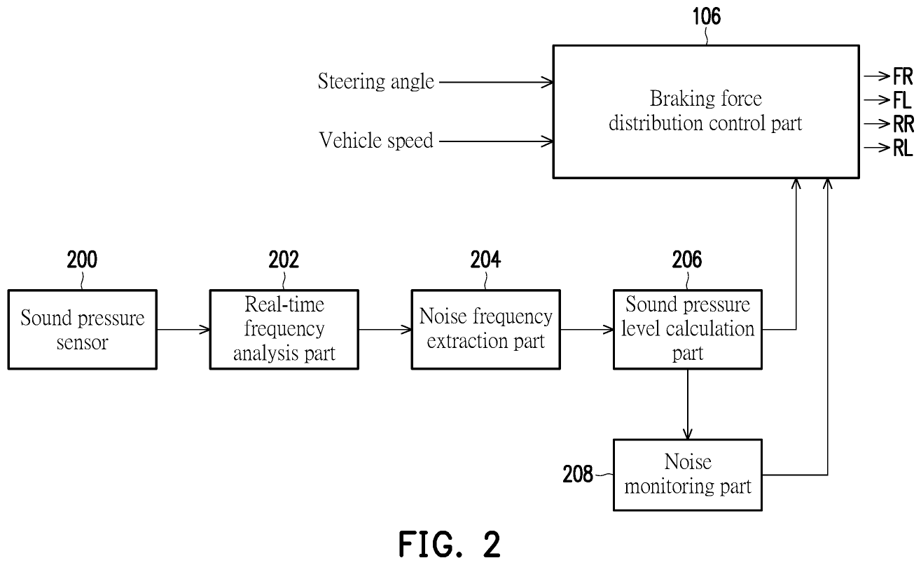

As shown in FIG. 2, the braking force distribution control part 106 generates a control amount for each wheel based on the vehicle speed and steering angle, and outputs the braking force command values FL, FR, RL, and RR of each wheel accordingly (command value transmission part 118). Furthermore, the braking force command values FL, FR, RL, and RR of each vehicle are set with a maximum limit. According to the braking force command values FL, FR, RL, and RR, the braking force and driving force of each wheel of the vehicle may be adjusted so that the vehicle may turn faster and more smoothly. However, when the vehicle is traveling at low speeds, the braking force distribution control of the braking force distribution control part 106 may cause brake noise to occur.

Moreover, the brake noise detection part 108 is for detecting brake noise of each wheel of the vehicle. The brake noise detection part 108 will be described in further detail later.

According to the embodiment of the present disclosure, when the braking force distribution control part 106 controls the braking force of each wheel of the vehicle and when the turning state detection part 102 determines that the vehicle is in a turning state and the vehicle speed detection part 104 determines that the vehicle speed is equal to or less than a predetermined threshold, if the brake noise occurs for multiple times within a predetermined time (for example, 1 minute), the control part 114 may suppress (or prohibit) the operation of the braking force distribution control part 106, that is, the braking force distribution control part 106 suppresses the executed braking force distribution control. Here, a state in which the vehicle speed is equal to or less than a predetermined threshold may refer to a state in which the vehicle is judged to be in a stopping state or a low-speed state close to a stopping state, which may be, for example, the driver's parking operation (forward, reverse, side parking), exiting the garage, turning, driving on a narrow road, or the automatic parking control part 110 is operating, etc.

FIG. 2 shows a block diagram of a brake noise detection part according to an embodiment of the present disclosure. As shown in FIG. 2, the sound pressure sensor 200 is used as an example here. For example, the sound pressure sensor 200 may adopt a microphone for a navigation device mounted in a vehicle cabin, so that the sound in the vehicle cabin may be detected.

After the sound pressure sensor 200 detects the sound in the vehicle cabin, the detected sound is further subjected to frequency analysis by the real-time frequency analysis part 202, and then frequency components related to brake noise is extracted through the noise frequency extraction part 204. Thereafter, the frequency components extracted by the noise frequency extraction part 204 are sent to the sound pressure level calculation part 206 to calculate the sound pressure level of the frequency components.

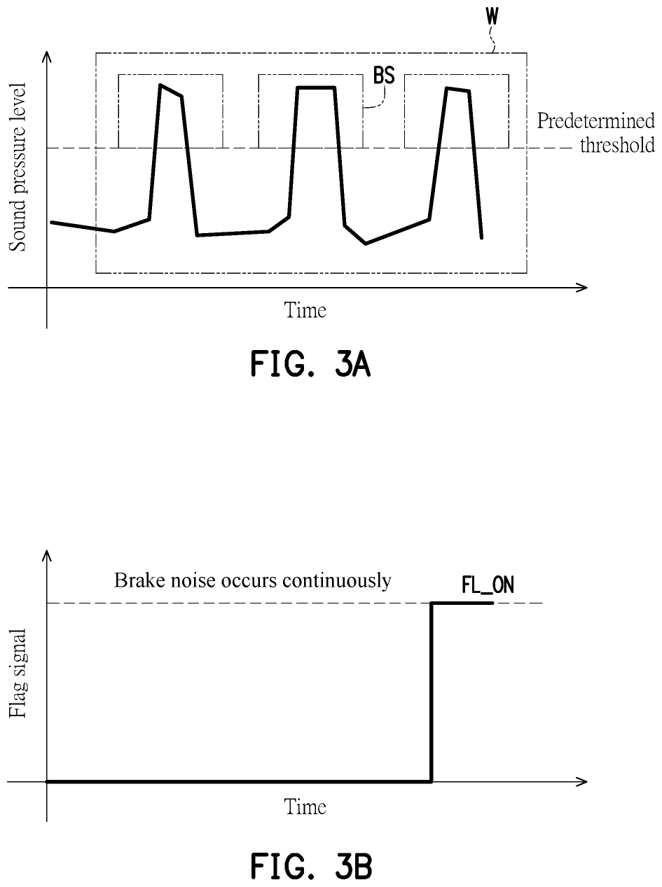

When the vibration level of the frequency component calculated by the sound pressure level calculation part 206 is equal to or higher than a predetermined threshold, the sound is determined to be brake noise. Afterwards, the noise monitoring part 208 detects whether brake noise occurs for multiple times within a predetermined time. For example, the sound pressure level calculation part 206 transmits the detected brake noise to the noise monitoring part 208. The noise monitoring part 208 may set a predetermined time, such as 1 minute, and monitor (count) whether the brake noise occur for multiple times within the predetermined time. That is, as shown in FIG. 3A, the noise monitoring part 208 may set a monitoring moving window (predetermined time) W. This monitoring moving window W has a prescribed time range and may move with time. The noise monitoring part 208 may monitor how many times brake noise BS occurs within the monitoring moving window W. When the noise monitoring part 208 determines that brake noise occurs for multiple times within the predetermined time t, as shown in FIG. 3B, the flag signal FL_ON may be generated to the braking force distribution control part 106 to inhibit the operation of the braking force distribution control part 106 (mandatory prohibition). That is, when the vehicle is turning at a low speed and brake noise continues to occur, the operation of the braking force distribution control part 106 is prohibited, thereby inhibiting the occurrence of brake noise.

Also, when brake noise is detected only once within a specified time, the following control may be performed under the circumstances to make the braking force of the inner wheel smaller. When such control is performed, if brake noise is detected n times, the braking force distribution control is prohibited. According to an embodiment of the present disclosure, the above-mentioned brake noise detection part 108 may include: a sound pressure sensor 200 for detecting the above-mentioned brake noise. The sound pressure sensor 200 may adopt, for example, a microphone for a navigation device (that is, a sound pressure microphone). Generally speaking, a navigation device is mounted inside a vehicle cabin, and the sound picked up by the microphone of the navigation device is brake noise from each wheel that the driver or passenger hears. In addition, the sound pressure sensor 200 does not adopt an existing microphone, but adopts a high-performance microphone sensor instead, or sound pressure sensors may be disposed in each brake caliper of the braking device 120.

According to another embodiment of the present disclosure, the brake noise detection part 108 may further include: an unsprung acceleration sensor 220 for detecting the unsprung acceleration of the vehicle. The unsprung acceleration sensor 220 is disposed near the suspension system of the vehicle, so the brake noise detected by the unsprung acceleration sensor 220 may be more accurate. By using dual sensors, false detections by the sound pressure sensor 200 may be reduced.

The determining part 112 of the vehicle control device 100 may be integrated with the control part 114 or be an independent execution component. The determination part 112 of the vehicle control device 100 determines brake noise based on the detection results of the sound pressure sensor 200 and the unsprung acceleration sensor 220. In addition, when the vehicle speed detection part 104 determines that the vehicle speed is equal to or less than the predetermined threshold, and the determining part 112 determines that brake noise occurs for multiple times, the control part 114 may suppress (or prohibit) the operation of the braking force distribution control part 106, that is, the braking force distribution control part 106 inhibits the executed braking force distribution control.

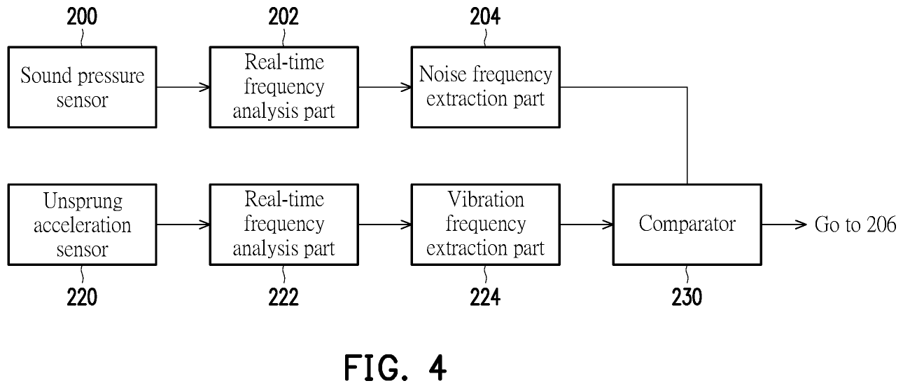

FIG. 4 is a block diagram in which the brake noise detection part 108 includes both the sound pressure sensor 200 and the unsprung acceleration sensor 220. As shown in FIG. 4, similar to the block diagram of FIG. 2, after the unsprung acceleration sensor (brake vibration detection part) 220 detects the vibration generated by the braking device 120, the detected vibration further performs frequency analysis through the real-time frequency analysis part 222, and then the frequency component related to the brake noise is extracted through the vibration frequency extraction part 224. Thereafter, the frequency components extracted by the noise frequency extraction part 204 and the frequency components extracted by the vibration frequency extraction part 224 are compared by the comparator 230, and the comparison results are sent to the sound pressure level calculation part 206 to calculate the sound pressure level of each frequency component.

In other words, brake noise is detected by the sound pressure sensor 200. Furthermore, based on the detection result of the unsprung acceleration sensor 220, the same frequency component as the brake noise detected by the sound pressure sensor 200 is sent to the sound pressure level calculation part 206. When the calculated vibration level of the frequency component (around 20 to 200 Hz, high-pitched pressure measurement during dragging) is higher the specified value, the sound is judged to be brake noise.

Afterwards, the noise monitoring part 208 detects whether brake noise occurs for multiple times within a predetermined time. If brake noise occurs for multiple times, the operation of the braking force distribution control part 106 is inhibited. By using the information detected by the sound pressure sensor (sound pressure microphone) 200 and the unsprung acceleration sensor 220, the frequency component of a specific brake noise may be extracted. When the sound pressure level of the extracted frequency component is equal to or higher than the predetermined threshold, the control amount of the braking force distribution control part 106 is reduced to inhibit the braking force distribution control executed by the braking force distribution control part 106.

According to this embodiment, brake noise is detected by the sound pressure sensor 200 and the unsprung acceleration sensor 220. Since the unsprung acceleration sensor 220 is further used in addition to the sound pressure sensor 200, the judgment accuracy of brake noise may be further improved. Based on this judgment result, the braking force distribution control executed by the braking force distribution control part 106 is inhibited, thereby more effectively suppressing the occurrence of brake noise.

In addition, the braking device 120 of the vehicle control device 100 applies a braking force to the vehicle based on the driver's operation of the brake operating part. The braking device 120 may impart braking force to the wheels of the vehicle to slow down the vehicle. The brake operating part is, for example, a brake pedal disposed below the driver's seat of the vehicle. The driver may depress the brake pedal to cause the braking device 120 to generate braking force on each wheel of the vehicle to decelerate or stop the vehicle.

Furthermore, when the vehicle speed detection part 104 detects that the vehicle speed of the vehicle is equal to or less than the predetermined threshold and when the braking force distribution control executed by the braking force distribution control part 106 is terminated (the braking force distribution control is inhibited), as the control part 114 detects the depression amount of the brake pedal, the braking device 120 may be controlled to generate a braking force corresponding to the operation of the brake operating part (i.e., the amount of depression of the brake pedal). Therefore, in order to inhibit the occurrence of brake noise, insufficient braking force may be compensated by the braking device 120 of the vehicle, so the deceleration performance of the vehicle may be maintained.

Therefore, according to the embodiment of the present disclosure, in the braking force distribution control executed by the braking force distribution control part 106, the braking force of the inner wheels of the vehicle is made greater than the braking force of the outer wheels. However, when the braking force distribution control is inhibited, the braking device 120 generates a braking force corresponding to the operation (depression amount) of the brake pedal.

Furthermore, the vehicle control device 100 has a power switch 140, that is, an engine start switch. When the driver presses the power switch 140, the electronic system of the vehicle may be started. Under the circumstances, the control part 114 of the vehicle control device 100 may perform various inspection procedures and the instrument panel of the vehicle also starts to display. Afterwards, when the driver presses the power switch 140 again, the engine of the vehicle may be started, making the vehicle in a drivable state. Moreover, the driver may also shut down the engine of the vehicle and shut down the electronic system of the vehicle by operating the power switch 140. Therefore, the power switch 140 may operate the driving source (engine) of the vehicle according to the driver's operation.

Furthermore, when the vehicle speed detection part 104 detects that the vehicle speed of the vehicle is equal to or less than the predetermined threshold, the braking force distribution control executed by the braking force distribution control part 106 is inhibited. Under the circumstances, the operation of the braking force distribution control part 106 will continue to be suppressed until the power switch 140 is turned off, that is, the braking force distribution control will remain in an inhibited state.

In this embodiment, if brake noise continues to exist, the braking force distribution control will continue to be suppressed until the power switch 140 of the vehicle is turned off. In this way, the occurrence of brake noise may be further suppressed.

The automatic parking control part 110 of the vehicle control device 100 at least controls the steering device (steering wheel) 130 of the vehicle to move the vehicle to a parking position based on the driving state of the vehicle. Here, the automatic parking control part 110 serves a vehicle parking assist function, and the function thereof is to assist the operation of the steering device (steering wheel) 130 during parking. When reverse parking and side parking are performed, the automatic parking control part 110 may make the steering device (steering wheel) 130 to operate automatically to drive the vehicle into the white-line frame of the parking space.

While the automatic parking control part 110 is executing the automatic parking control, as the braking force distribution control executed by the braking force distribution control part 106 is suppressed, the steering device 130 is controlled so that the turning radius of the vehicle is smaller than the current turning radius. That is, when the braking force distribution control is suppressed, the automatic parking control part 110 controls the steering device 130 to apply a control torque to the steering device 130 so as to reduce the turning radius.

Since the braking force distribution control executed by the braking force distribution control unit 106 is suppressed, the turning radius of the vehicle becomes larger. Even so, the present disclosure may control the steering device 130 through the automatic parking control part 110 so that the turning radius of the vehicle becomes smaller, that is, smaller than the current turning radius. Therefore, according to the embodiment of the present disclosure, when the operation of the braking force distribution control part 106 is suppressed, the control part 114 further causes the automatic parking control part 110 to perform automatic parking control. In this way, the operation of the braking force distribution control part 106 is suppressed to inhibit the occurrence of brake noise, and the automatic parking control part 110 may reduce the turning radius of the vehicle while maintaining the turning performance.

According to the above embodiment, when the vehicle speed is equal to or less than the predetermined threshold, the vehicle is in a low-speed state, and when brake noise occurs continuously, the braking force distribution control may be disabled, thereby suppressing the occurrence of brake noise.

Furthermore, in addition to the above embodiments, the vehicle control device 100 of the present disclosure may further include an HMI switch detection part 118 for detecting whether a switch (human machine interface: HMI) for prohibiting braking force distribution control is turned on or off. The braking force distribution control disabling switch allows the driver to freely disable/enable the braking force distribution control.

Finally, it should be noted that the above embodiments are only used to illustrate the technical solution of the present disclosure, but not to limit it. Although the present disclosure has been described in detail with reference to the foregoing embodiments, those of ordinary skill in the art should understand that: The technical solutions described in the foregoing embodiments can still be modified, or some or all of the technical features can be equivalently replaced; and these modifications or substitutions do not deviate from the essence of the corresponding technical solutions from the scope of the technical solutions of the embodiments of the present disclosure.

What is claimed is:

1. A vehicle control device, comprising:
a turning state detection part for detecting whether a vehicle is in a turning state based on a driving state of the vehicle;
a vehicle speed detection part for detecting whether a vehicle speed of the vehicle is equal to or less than a predetermined threshold;
a braking force distribution control part for distributing and controlling a braking force of each wheel of the vehicle based on the driving state and the vehicle speed; and
a brake noise detection part for detecting a brake noise of each of the wheels,
wherein when the braking force distribution control part controls the braking force and when the vehicle is in the turning state and the vehicle speed is equal to or less than the predetermined threshold, when the brake noise occurs for a plurality of times within a predetermined time, a braking force distribution control of the braking force distribution control part is suppressed.

2. The vehicle control device according to claim 1, further comprising:
a braking device that applies the braking force to the vehicle based on a driver's operation on a brake operating part,
wherein when the vehicle speed is equal to or less than the predetermined threshold and when the braking force distribution control is terminated, the braking device generates the braking force corresponding to an operation of the brake operating part.

3. The vehicle control device according to claim 2, further comprising:
a power switch configured to cause a driving source of the vehicle to operate according to the driver's operation,
wherein when the vehicle speed is equal to or less than the predetermined threshold and the braking force distribution control is suppressed, the braking force distribution control part maintains a state in which the braking force distribution control executed by the braking force distribution control part is suppressed until the power switch is turned off.

4. The vehicle control device according to claim 3, further comprising:
an automatic parking control part configured to at least control a steering device of the vehicle according to the driving state of the vehicle to move the vehicle to a parking position,
wherein when the braking force distribution control is suppressed while the automatic parking control part is performing an automatic parking control, the steering device is controlled so that a turning radius of the vehicle is smaller than a current turning radius.

5. The vehicle control device according to claim 1, wherein the brake noise detection part comprises: a sound pressure sensor that detects the brake noise, and an unsprung acceleration sensor that detects unsprung acceleration of the vehicle,
wherein the vehicle control device further comprises a determining part that determines the brake noise based on detection results of the sound pressure sensor and the unsprung acceleration sensor,
wherein when the vehicle speed is equal to or less than the predetermined threshold and when the determining part determines that the brake noise occurs for a plurality of times, the braking force distribution control part suppresses the braking force distribution control.

6. A vehicle control method, comprising:
detecting whether a vehicle is in a turning state based on a driving state of the vehicle;
detecting whether a vehicle speed of the vehicle is equal to or less than a predetermined threshold;
distributing and controlling a braking force of each wheel of the vehicle based on the driving state and the vehicle speed to perform a braking force distribution control;
detecting a brake noise of each of the wheels;
in controlling the braking force, when the vehicle is in the turning state and the vehicle speed is equal to or less than the predetermined threshold and when the brake noise occurs for a plurality of times within a predetermined time, suppressing the braking force distribution control.
